(19) United States
(12) Patent Application Publication
(10) Pub. No.: US 2026/0037349 A1
(43) Pub. Date: Feb. 5, 2026

(54) IMMERSIVE ENGAGEMENT PLATFORM CREATION SYSTEM

(71) Applicant: Armen Hacopian-Armen, Brooklyn, NY (US)

(72) Inventor: Armen Hacopian-Armen, Brooklyn, NY (US)

(21) Appl. No.: 19/009,397

(22) Filed: Jan. 3, 2025

Related U.S. Application Data
(60) Provisional application No. 63/678,371, filed on Aug. 1, 2024.

(51) Int. Cl. G06F 9/54

(52) U.S. Cl. CPC G06F 9/547

(57) ABSTRACT

An immersive content rendering engine configured to convert remote, cloud-based content data and content metadata into an actionable rendering in an immersive environment residing on a legacy immersive platform. The immersive content rendering engine serves as a channel between the immersive environment and the extracted immersive content data by way of a proprietary application programming interface system.

### CROSS REFERENCE TO RELATED APPLICATION

This application claims the benefit of priority of U.S. provisional application No. 63/678,371, filed Aug. 1, 2024, the contents of which are herein incorporated by reference.

### BACKGROUND OF THE INVENTION

The present invention relates to immersive engagement platforms and, more particularly, to an immersive engagement platform creation system.

Content providers and advertisers are constantly seeking user engagement, ideally through a totally new way of engaging fans of entertainment providers. By way of example, recent research identifies immersive website usage as one of the main engines of increasing sports fan engagement with content providers and advertisers. Specifically, the research shows that more than two-thirds of fans would rather engage with their favorite team's immersive space than its website. The research also shows that over half of sports fans would rather purchase merchandise on their favorite team's immersive space than its website. Likewise, the research has found that more than two-thirds of fans between the ages of 13-34 would, if available, look for social interaction with their fellow fans in their favorite teams' immersive space, while over half of these sports fans would pay to attend immersive events to interact with their favorite team's athletes. Moreover, a study by Deloitte™, a consulting and advisory service provider, found that sports fans want engagement year-round with their favorite teams, including the off-season.

Further research shows that immersive 3D web experiences significantly impact user engagement and conversion metrics across various platforms. Such experiences can effectively hold visitors' attention, making content more memorable and engaging through storytelling, personalization, and interactive features.

Currently, there is no solution in the marketplace which provides fans with a rich, immersive connection to their favorite sports teams and clubs. One reason why there is a dearth of such immersive spaces is the intrinsic and structural limitation built into the current immersive topography-because immersive space creation requires massive computational power, the limited platforms that provide the fertile infrastructure to create robust immersive spaces are incentivized to lock users into their platform and all if its inherent limitations, and thereby frustrate solutions that aim to create an immersive space that picks and chooses the best immersive features from a plurality of platforms. In short, the ‘multiverse’ of immersive space currently consists of uncommunicative silos.

As can be seen, there is a need for an immersive engagement platform creation engine.

### SUMMARY OF THE INVENTION

The subject disclosure includes an immersive platform creation system that embodies an immersive platform engine (“engine” is akin to the term “software engine” used more widely in the software industry) and a set of specialized design tools for creating an immersive engagement platform offering links between fandom and sponsor content. In the embodiment where the fans are that of a sports team, the immersive engagement space, afforded by the systemic immersive engagement platform, provides digital sponsor advertising, via portal, in the sports team's immersive space where fan interactions are intermingled with the sport team's website and marketing to provide visually appealing content, cutting-edge technology, advanced analytics, metrics and reporting. The immersive engagement platform is inherently scalable and customizable through the systems and methods disclosed herein.

The systemic immersive engagement platform provides infrastructure on which software is executed so that a creator or designer can create an immersive engagement platform. The system of the subject disclosure may include a rendering engine (“renderer”) for 3D graphics, sound, scripting, animation, artificial intelligence, networking, streaming, memory management, and the like configurable to define a metaverse composed of selected elements.

The immersive engagement platform provides content through cloud-based platform-targeted libraries, support programs and development software supporting a framework or a suite of tools and features for developing an immersive platform. Designers can also use the systemic immersive engagement platform and integrated creation and rendering engines to construct one or more immersive spaces residing on and via a network of computers, particularly legacy immersive platforms.

Through a content retrieval and deployment system, the systemic platform enables content decoupling from cloud computing service by way of a proprietary application programming interface (PAPI) configured to define content data different types, retrieved from cloud services for deployment on legacy immersive platforms. The systemic platform provides placement technology for creation of an absolute 3D position (x, y, z) or relative 3D position to a predefined area in a multitude of immersive spaces, whereby this relative positioning allows non-technical operators to easily deploy complex 3D content to immersive spaces, while allowing customizable technology additions.

More specifically, PAPI is configured to interface with client cloud services (e.g., Microsoft Azure™, Amazon Web Services™, Google Cloud Platform™ and the like or “cloud services” created on behalf of a platform client) to add, remove, update, and retrieve content data associated with immersive content from these underlying cloud services, while also adding, removing, updating, and retrieving content metadata associated with the content data for enabling immersive content description and placement details for the immersive environment to be populated with the content data. So configured, PAPI is enabled to add, remove, update, and retrieve industry catered content, e.g. sports industry content would be stadiums, locker rooms, executive lounge, authentic trophy rooms, etc. for populating an immersive engagement space.

Through this cloud component of PAPI, the systemic platform can retrieve all content data (2D, 3D, text, audio, video, charts) along with associated unique identifiers of the content data and corresponding content metadata (3D position in the immersive space either as an absolute position or relative to other content in the space, data type e.g. an advertisement, description, textual or binary format, purpose of the content, area of the content, associated web links for the content, e.g. news articles, etc.). The systemic platform, also by way of the PAPI, can create specific content using its unique identifier and provided content data and content metadata. As a result, downstream the systemic platform can update specific content data using its unique identifier and associated content data and content metadata.

The subject disclosure, also through the PAPI system, enables product decoupling from legacy immersive platforms (e.g., Meta Horizons World™, Roblox™, and Spatial.io) by providing a uniform way to interact with underlying immersive platforms. The subject disclosure provides an API wrapper around Unity compatible platforms like Meta Horizons World and Spatial.io, as well as an API wrapper around non-Unity compatible platforms like Roblox. Thereby, the subject disclosure enables underlying platform detection via deployment-time settings mechanism where it instructs the PAPI systems to use specific immersive platform implementation at runtime, thereby allowing customizable tech additions, e.g. 3D volumetric video streaming via 3rd party providers. Deployment-time settings are JSON based data that instruct the system at runtime which specific PAPI to utilize for rendering content in the underlying immersive platform. This mechanism also makes the system easily extensible by extending the PAPI, allowing it to support immersive platforms that may not even be currently available.

In another aspect of the invention, a method of populating a legacy immersive platform includes the following: retrieving immersive content data from a cloud computing environment by way of an application programming interface (API) configured to provide relative placement data for each data set; and deploying, by way of the API configured to selectively deploy the immersive content data through the relative placement data, on the legacy immersive platform.

In another aspect of the invention, the method of populating a legacy immersive platform further provides the following: wherein the API is configured to enable peripherals to operatively associate with the deployed immersive content data, wherein the relative placement data comprises an indicator for each data set of the immersive content data, wherein the indicator is linked with content metadata associated with each data set, and wherein the content metadata comprises metadata position, data metadata type, and metadata description of the data set; and encapsulating a legacy software application from another legacy immersive platform in an API wrapper; and deploying said encapsulated legacy software application in said legacy immersive platform.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of an immersive engagement platform 100 configured for providing immersive space on a browser, smart device and other immersive-enabled peripherals 10 by way of a leveraging both the infrastructure components of a plurality of legacy immersive experience platform 20 and the content data component found on remote cloud services, and then selectively intermingling these infrastructure and content components in a novel immersive space. The immersive engagement platform 100 employs a novel proprietary application programming interface (PAPI) module 200 having a cloud PAPI submodule 210 that enables use of graphics, animation, and other content creation programs 30 to populate the immersive space with immersive content data, content metadata, and associated descriptions, placement details, and catered content—using a unique identifier system-from library content of the creation programs 30 also residing on computing cloud services 300.

FIG. 2 is a detailed schematic view of FIG. 1, illustrating content retrieval element of the subject disclosure.

FIG. 3 is a schematic view illustrating immersive content (2D, 3D, text, audio, video, charts) data retrieval, which returns the unique identifiers of content data and corresponding metadata (3D position in the immersive space either an absolute position or relative to other content in the space, data type, description, textual or binary format, purpose of the content, area of the content, associated web links for the content, e.g. news articles, etc.). The systemic platform, also by way of the PAPI system, can create specific content using unique identifiers of associated content data and content metadata (as explained previously with examples). Likewise, the systemic platform can update specific content using its unique identifier and provided data and metadata

FIG. 4 is a detailed schematic view of FIG. 1, illustrating content deployment for the subject disclosure.

FIG. 5 is a schematic view of the subject disclosure, diagrammatically illustrating product decoupling from legacy immersive platforms through an API wrapper 50 of the PAPI 200.

FIG. 6 is a schematic view of the subject disclosure, illustrating PAPI 200 functionality of the API wrapper 50 by way of an example. In this exemplary utilization, a credit card transactions processing component is missing from a unity-powered Spatial.io immersive platform 21, but Roblox immersive platform 22 has that credit card transactions processing component; whereby PAPI 200 functionality provides its own transaction processing for an immersive space created on the Spatial.io immersive platform 21 by way of said API wrapper 50 interfacing with Roblox immersive platform 22, so that the immersive space creator of novel immersive platform 100 uses the built-in Roblox immersive platform 22 credit card transactions transaction processing while the novel immersive space is reside on Roblox immersive platform 22.

FIG. 7 is a schematic view of the subject disclosure, illustrating a Project Lit embodiment thereof.

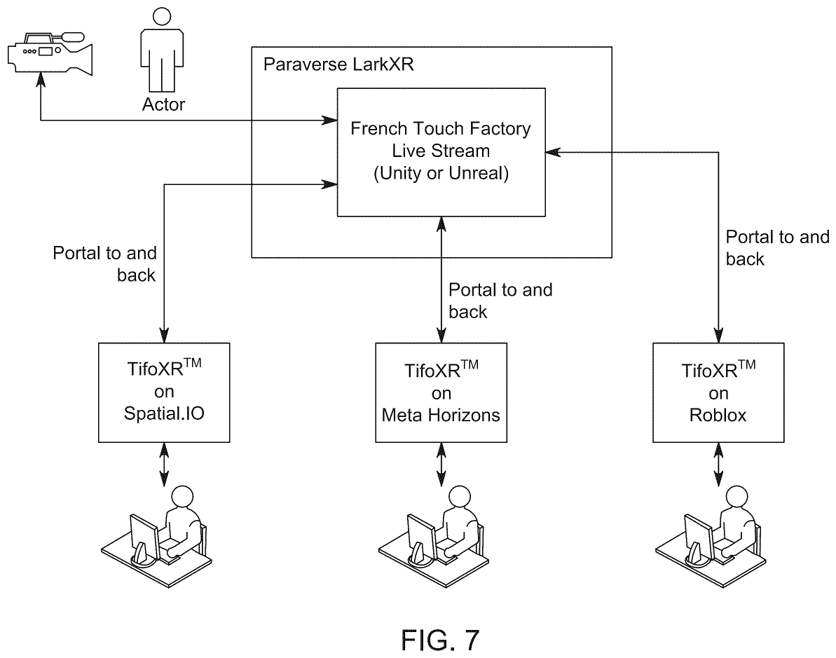

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

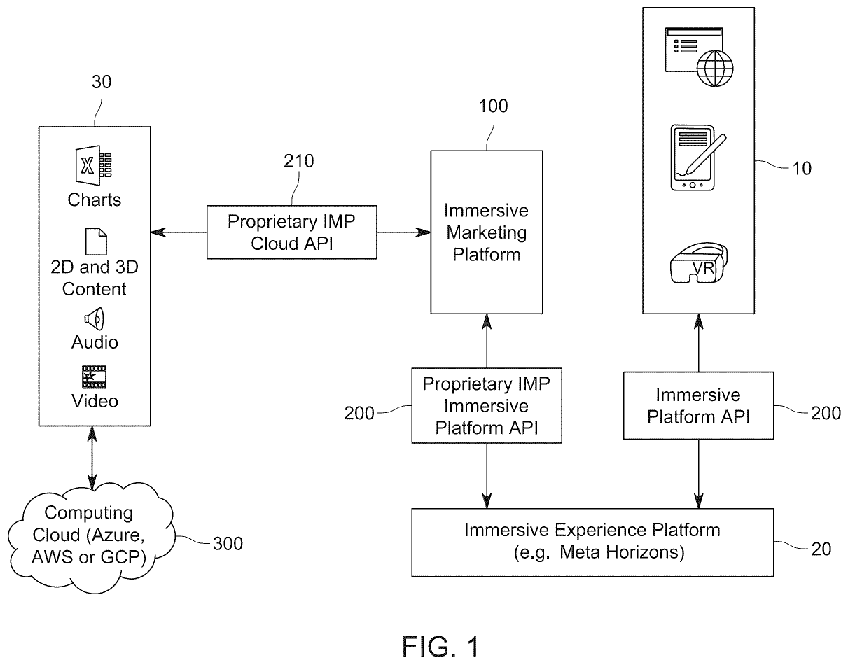

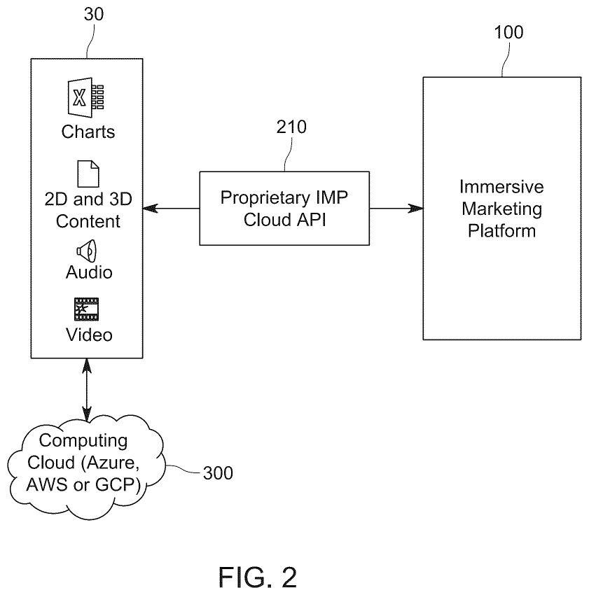

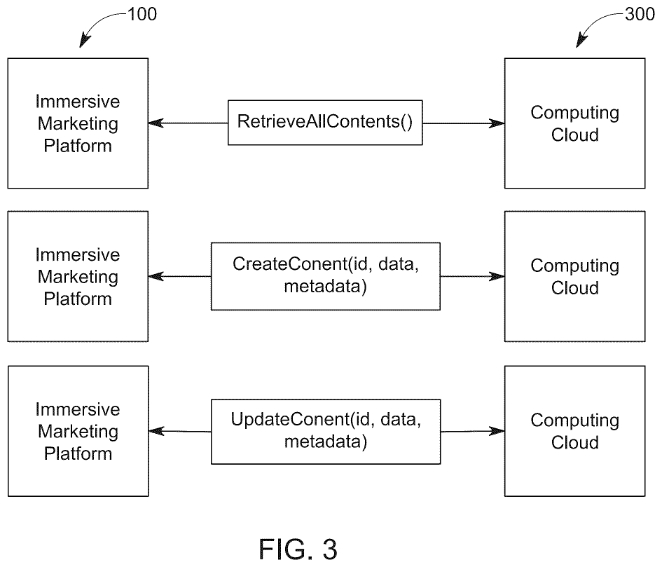

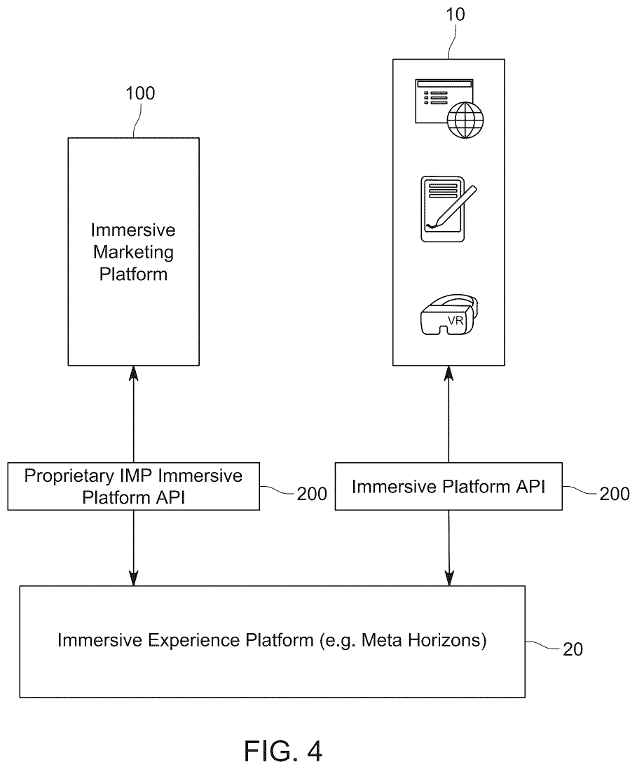

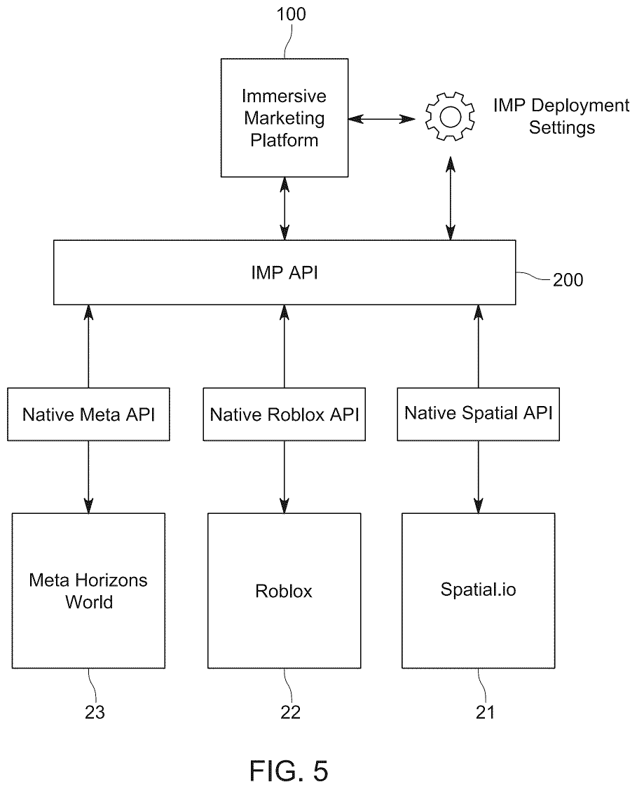

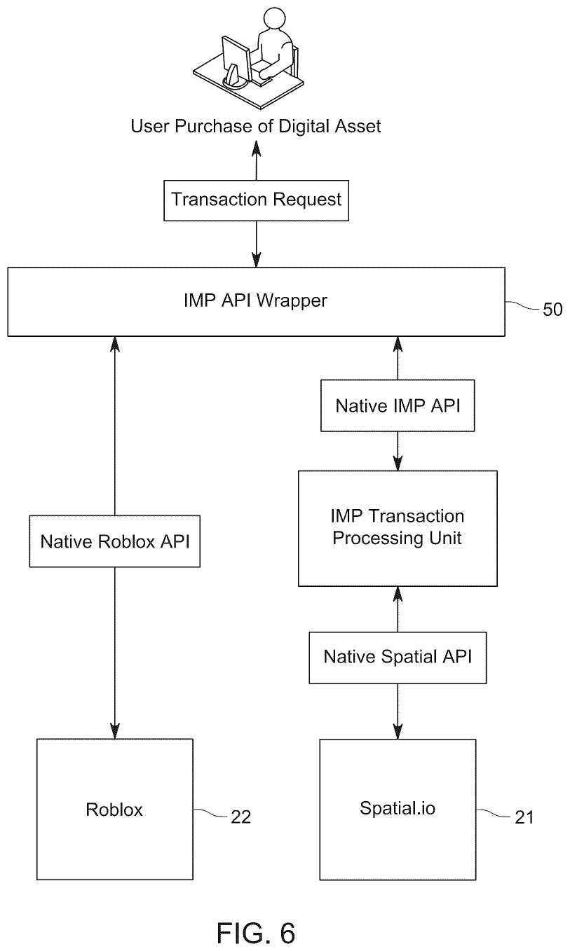

Referring to FIGS. 1 through 6, the present invention discloses an immersive content rendering engine. This system converts remote, cloud-based content data and content metadata into an actionable rendering in an immersive environment residing on a legacy immersive platform, wherein the immersive content rendering engine of the present invention, in some embodiments, serves as a channel between the immersive environment and the extracted immersive content data by way of proprietary application programming interface.

The immersive content rendering engine enables an immersive marketing platform for providing fans a one-stop shop where authors deploy and maintain 2D/3D/text/audio/video/charts and other media to the 3D immersive spaces populated by fan-based content.

The immersive marketing platform may provide curated areas in the immersive environment. By way of example, if the fans of the immersive environment are, say sports fans of a specific sports club, of the immersive environment may provide an authentic, intricate and high-fidelity 3D model of the club's stadium in which fans can play around socially to pass time or otherwise interact with other fans, club content, and digital advertisement. The immersive environment may provide executives bio and other related medica is available for fans; where club newsfeeds are updated with links to club website or other relevant sites where fans across the globe can gather, chat (by voice or text), make new friends, plan their trips to see their beloved club's games, and where fans can purchase digital and physical merchandise, gift them to their friends. The environment will also provide a reward system to keep the fans occupied with club content and merchandise. The immersive environment may provide portals to sponsor spaces for fans to discover and visit and learn about the sponsors (i.e., the sport club monetizes from this traffic to the sponsors spaces) and where fans can learn about the glorious past of the club with plenty of 3D/2D and other media. The immersive environment may provide latest dynamic league standings, integration with clubs favorite ticketing systems or club website, monetized digital events where fans can view their idols or club staff in 2D live video feed, recorded footage or 3D volumetric live video feed or 3D footage, where technical staff can post their latest drills, trainings, announcements etc. The immersive environment may provide the current team members and where fans can see authentic locker room of the players and perhaps chat with athletes when they make unannounced visits, and where latest 2D/3D images and videos can be displayed by the club.

Current legacy immersive environments are based on a proprietary tech stack which forces clients to lock into their legacy technology. The 3D immersive metaverse industry is contested by big names (e.g. Meta and Roblox) and lots of other smaller companies. The subject disclosure provides a new and non-obvious alternative; a product that runs on any immersive infrastructure/platform through the loose coupling supported by the aforementioned retrieval and deployment system, which will continue to operate when the legacy company with underlying immersive space discontinues for any reason. Also, as mentioned, this loose coupling will allow support (by means of PAPI implementation) for new and upcoming immersive infrastructure platforms that are not currently available.

Furthermore, the present invention may be the basis for an immersive marketing platform that may be easily deployed, curated and custom content and assets from any cloud (Microsoft Azure, AWS, Google Cloud) seamlessly and allow users to place them in the 3D space.

The subject disclosure enables the following features for fans: authentic 3D club stadium experience, authentic locker room and facilities authentic hall of fame/team story team roster; league standings; immersive video player content social experience with other fans; social interactions with athletes; and digital and physical shop all-in-one experience.

The subject disclosure enables the following features for clubs: fan engagement with increased fan acquisition and retention; links to merchandise shops (physical/digital) providing revenue opportunity with distinct spaces for increased inclusivity, social responsibility and sponsorship portals and related revenue opportunity. Stadium and facility branding and sponsorship opportunities/advertising social engagement with voice and text chat are enabled by the present invention. Promotion for mixed-use facilities and related revenue opportunity as well as augmenting existing websites and marketing assets 100% customizable with authentic assets are also available through the present invention.

Lastly, immersive marketing platforms brings spectator-sports related activities and areas in one place, making it a one-stop-shop for fans to not only form a deeper bond with their clubs but also forge lasting friendships between each other through more social interaction. The subject disclosure can also integrate with major ticketing platforms, as well as credit card and crypto payments as well as curate.

Multiple new revenue streams for teams (merchandise, sponsorship, events, ticketing) are also enabled by the present invention. Likewise, revenue streams via sponsor spaces may be linked to team space via portals, where revenue streams with digital sponsor advertising in team space immersive experiences to engage fans exist. Social fan interactions via voice and text messaging; rapid, automated news and media updates via deployment tool library integration with existing team website and marketing apparatus are also enabled by the subject disclosure. The immersive marketing platform can keep fans on team's digital premises through scalable and customizable designs that can address teams of all sizes since the present invention may leverage immersive platform-agnostic products (e.g. Meta Horizon Worlds, Roblox, Spatial); visually appealing content, cutting-edge technology available on current devices; and advanced analytics, metrics and reporting functionality affording by cloud services that is retrieved therefrom and deployed in immersive environments operable on any and all legacy immersive platforms.

The subject disclosure may provide a reward system. The goal of the reward system is to encourage guests of immersive experiences to stay longer and interact with the platform and each other. The system will reward the guests in immersive experience currency: When guests purchase merchandise; When guests gift merchandise to each other; When guests stay for a minimum amount of time; When guests frequent multiple times in a day; When guests frequent multiple days in a row; When guests interact more than a threshold with other guests, via voice or messaging; When guests visit and interact with all the booths/areas in the immersive space; When guests complete host/sports club quests; and When guests receive badges for being recognized by the club, e.g. for being best Fan of the Month. Badges could be showcased in the immersive space.

The subject disclosure may provide currency having multiple modes of payment in the immersive space. However, there would be two main currencies: Infrastructure Coins: Underlying immersive infrastructure currency. E.g. Spatial Coins or Roblox Robux, where credit cards or gift cards can be used to purchase immersive space currency; and Sports Crypto: Integration of major sports crypto currencies that are already in use by fans globally to purchase digital merchandise, digital events, sporting tickets, etc.

The subject disclosure may provide LIT Integration: TifoXR™ is the entry point to LIT application. Millions of guests will frequent different TifoXR™ spaces and will join exclusive events. TifoXR™ may or may not monetize entry to these events depending on the hosts' requests.

The subject disclosure also contemplates Project LIT, an application the utilized 3D cloud streaming product LarkXR (developed by Paraverse Technology a Hong Kong company) and 3D volumetric video generation product Ithaca (developed by French Touch Factory a Paris, France company). The innovation is the unique marriage and utilization of these two technologies in conjunction with TifoXR™ immersive engagement product (built by Armen Hacopian-Armen using IMP—Immersive Marketing Platform). This unique technology usage has never been attempted. The rationale behind Project

What does LIT Do?

LIT allows for high-fidelity 3D volumetric live and recorded streaming in the Web viewable from any desktop, laptop, smartphone without the requirement for powerful and expensive Graphics Processing Unit (GPU). This empowers users globally to enjoy a sporting event, interview live and be able to view the subject from every angle on any device with Internet connectivity.

### What is 3D Cloud Streaming?

A Paraverse company proprietary real-time 3D XR cloud streaming and rendering solution that allows for high-fidelity 3D applications to be hosted and streamed on cloud infrastructure with ultra-low latency by efficiently using and sharing workload across the GPU clusters available on all major cloud infrastructures.

### What is 3D Volumetric Video?

3D Volumetric Video and audio is based on holographic technology and allows for generation of live or recorded 3D video capture using multiple cameras (1 to 10 usually) to project a full-size holographic video. Currently 3D volumetric video capture relies heavily on the client hardware and installed GPUs to be able to have low latency streaming. Ithaca (Immersion and Training with Holograms for Arts, Crafts and Audiovisual) developed by French Touch Factory uses state-of-the-art 3D video capture but is limited to the host GPU power.

### What is TifoXR™?

TifoXR™ is an immersive sports fan engagement, branding and marketing platform built on Immersive Marketing Platform (IMP). It allows several concurrent users to interact with each other and the sporting entity they follow in 3D and improve their experience.

### What is LIT?

LIT is a Unity based 3D application that employs Ithaca to render a sporting event or interview video capture. LIT is deployed on cloud infrastructure using LarkXR technology to provide low latency high-fidelity video streaming.

TifoXR™ users can hop on LIT to enjoy a 3D video event (live or recorded) and return to TifoXR™. Users can see upcoming 3D events in LIT, select to participate and view the past events that they had signed up for.

### What is the LIT Innovation?

LIT quite simply employs two separate technologies, cloud streaming using cloud GPU infrastructure and 3D video capture and streaming to bring an innovative solution to any industry but specifically to sports industry. LIT seamlessly integrates with TifoXR™ and allows users already signed on TifoXR™ to use SSO (Single Sign-On) and enjoy the 3D events on any device in highest fidelity with ultra-low latency. LIT allows users to message and/or use voice interaction with interviewer/event arbitrator to ask questions.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations, one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

What is claimed is:

1. A method of populating a legacy immersive platform, the method comprising:
retrieving immersive content data from a cloud computing environment by way of an application programming interface (API) configured to provide relative or absolute placement data for each data set; and
deploying, by way of the API configured to selectively deploy the immersive content data through the relative or absolute placement data, on the legacy immersive platform.

2. The method of claim 1, wherein the API is configured to enable peripherals to operatively associate with the deployed immersive content data.

3. The method of claim 2, wherein the relative placement data comprises an indicator for each data set of the immersive content data, wherein the indicator is linked with content metadata associated with each data set, and wherein the content metadata comprises metadata position, data metadata type, and metadata description of the data set.

4. The method of claim 3, the method further comprises:
encapsulating a legacy software application from another legacy immersive platform in an API wrapper; and
deploying said encapsulated legacy software application in said legacy immersive platform.
